(19) United States
(12) Patent Application Publication
(10) Pub. No.: US 2026/0229192 A1
(43) Pub. Date: Aug. 6, 2026

(54) DISPLAY DEVICE AND ELECTRONIC DEVICE

(71) Applicant: Samsung Display Co., Ltd., Yongin-si (KR)

(72) Inventors: SEUNGCHAN LEE, Yongin-si (KR); SUNG-JIN KIM, Yongin-si (KR); Sangtae PARK, Yongin-si (KR)

(21) Appl. No.: 19/386,963

(22) Filed: Nov. 12, 2025

(30) Foreign Application Priority Data
Feb. 3, 2025 (KR) 10-2025-0012958

(51) Int. Cl. G09G 3/3275; G09G 3/32; G09G 3/3266

(52) U.S. Cl. CPC G09G 3/3275; G09G 3/32; G09G 3/3266; G09G 2300/0819; G09G 2310/0267; G09G 2310/0275; G09G 2310/0297

(57) ABSTRACT

A display device includes: a display panel including a first pixel connected to a first data line and a scan line, and a second pixel connected to a second data line and the scan line; a scan driving circuit configured to output a scan signal to the scan line; a data driving circuit configured to output a data signal; and a demultiplexer configured to provide the data signal to the first data line and the second data line, wherein the demultiplexer includes: a switching circuit configured to deliver the data signal to the first data line in response to a first switching signal and to deliver the data signal to the second data line in response to a second switching signal; and a bypass circuit configured to electrically connect the first data line and the second data line to a bypass voltage line in response to a third switching signal.

### CROSS-REFERENCE TO RELATED APPLICATION

The present application claims priority to and the benefit of Korean Patent Application No. 10-2025-0012958, filed on Feb. 3, 2025, in the Korean Intellectual Property Office, the entire disclosure of which is incorporated herein by reference.

### BACKGROUND

Aspects of some embodiments of the present disclosure described herein relate to a display device and an electronic device.

Electronic devices such as televisions, mobile phones, tablet computers, navigation devices, and game consoles generate images and display the generated images to users through display screens.

Each electronic device includes a plurality of pixels and driving circuits that allow the plurality of pixels to display an image. Each of the plurality of pixels includes a light emitting element and transistors for controlling the light emitting element.

The above information disclosed in this Background section is only for enhancement of understanding of the background and therefore the information discussed in this Background section does not necessarily constitute prior art.

### SUMMARY

Aspects of some embodiments of the present disclosure described herein relate to a display device, and for example, relate to a display device that displays images, and an electronic device including the same.

Aspects of some embodiments of the present disclosure include a display device with relatively improved image display quality, and an electronic device including the same.

According to some embodiments, a display device includes a display panel including a first pixel connected to a first data line and a scan line, and a second pixel connected to a second data line and the scan line, a scan driving circuit that outputs a scan signal to the scan line, a data driving circuit that outputs a data signal, and a demultiplexer that provides the data signal to the first data line and the second data line. According to some embodiments, the demultiplexer includes a switching circuit that delivers the data signal to the first data line in response to a first switching signal and delivers the data signal to the second data line in response to a second switching signal, and a bypass circuit that electrically connects the first data line and the second data line to a bypass voltage line in response to a third switching signal.

According to some embodiments, the bypass circuit may include a first bypass transistor connected between the first data line and the bypass voltage line and turned on in response to the third switching signal, and a second bypass transistor connected between the second data line and the bypass voltage line and turned on in response to the third switching signal.

According to some embodiments, a ground voltage may be provided to the bypass voltage line.

According to some embodiments, an active level period of the scan signal may not overlap an active level period of the third switching signal.

According to some embodiments, the demultiplexer may be on the display panel.

According to some embodiments, a display device includes a display panel including a plurality of first pixels connected to a plurality of first data lines and a scan line, and a plurality of second pixels connected to a plurality of second data lines and the scan line, a scan driving circuit that outputs a scan signal to the scan line, a data driving circuit that outputs a plurality of data signals, and a demultiplexer that provides the plurality of data signals to the plurality of first data lines and the plurality of second data lines. According to some embodiments, the demultiplexer includes a switching circuit that delivers the plurality of data signals to the plurality of first data lines in response to a first switching signal and delivers the plurality of data signals to the plurality of second data lines in response to a second switching signal, and a bypass circuit that connects the plurality of first data lines to a bypass voltage line and connects the plurality of second data lines to the bypass voltage line, in response to a third switching signal.

According to some embodiments, the bypass circuit may include a plurality of bypass transistors, each of which is connected between the bypass voltage line and a corresponding data line among the plurality of first data lines and the plurality of second data lines, and which are turned on in response to the third switching signal.

According to some embodiments, a ground voltage may be provided to the bypass voltage line.

According to some embodiments, an active level period of the scan signal may not overlap an active level period of the third switching signal.

According to some embodiments, the display panel may include an edge area and a center area placed sequentially in a first direction. According to some embodiments, the scan driving circuit may be placed adjacent to the edge area. According to some embodiments, among a plurality of bypass transistors, a size of a bypass transistor corresponding to the center area may be greater than a size of a bypass transistor corresponding to the edge area.

According to some embodiments, the display panel may include a center area and an edge area placed sequentially in a first direction. According to some embodiments, the scan driving circuit may be placed adjacent to the edge area. According to some embodiments, each of a plurality of bypass transistors may be placed sequentially in the first direction. According to some embodiments, a size of each of the plurality of bypass transistors may gradually decrease in the first direction.

According to some embodiments, the display panel may include a center area and an edge area placed sequentially in a first direction. According to some embodiments, the scan driving circuit may be placed adjacent to the edge area. According to some embodiments, each of a plurality of bypass transistors may be placed sequentially in the first direction. According to some embodiments, among the plurality of bypass transistors, the third switching signal may be provided sequentially from a bypass transistor corresponding to the center area to a bypass transistor corresponding to the edge area.

According to some embodiments, the display panel may include a center area and an edge area placed sequentially in a first direction. According to some embodiments, the data driving circuit may include a first driving circuit corresponding to the center area and a second driving circuit corresponding to the edge area. According to some embodiments, the first driving circuit may provide the third switching signal to a clock line.

According to some embodiments, each of the plurality of first pixels may include a first transistor connected between a first node and a second node and including a gate electrode, a second transistor connected between one of the plurality of first data lines and the first node and including a gate electrode receiving the scan signal, and a third transistor connected between the second node and the gate electrode of the first transistor and including a gate electrode receiving the scan signal.

According to some embodiments, an electronic device includes a processor that outputs an image signal and a control signal, and a display module that displays an image in response to the image signal and the control signal. According to some embodiments, the display module includes a display panel including a first pixel connected to a first data line and a scan line, and a second pixel connected to a second data line and the scan line, a scan driving circuit that outputs a scan signal to the scan line, a data driving circuit that outputs a data signal, and a demultiplexer that provides the data signal to the first data line and the second data line. According to some embodiments, the demultiplexer includes a switching circuit that delivers the data signal to the first data line in response to a first switching signal and delivers the data signal to the second data line in response to a second switching signal, and a bypass circuit that electrically connects the first data line and the second data line to a bypass voltage line in response to a third switching signal.

According to some embodiments, the bypass circuit may include a first bypass transistor connected between the first data line and the bypass voltage line and turned on in response to the third switching signal, and a second bypass transistor connected between the second data line and the bypass voltage line and turned on in response to the third switching signal. According to some embodiments, a ground voltage may be provided to the bypass voltage line.

According to some embodiments, the display panel may include a display area and a non-display area adjacent to the display area. According to some embodiments, the first pixel and the second pixel may be placed in the display area. According to some embodiments, the demultiplexer may be placed in the non-display area. According to some embodiments, the demultiplexer may include at least one bypass transistor.

According to some embodiments, an active level period of the scan signal may not overlap an active level period of the third switching signal.

According to some embodiments, the display panel may receive a first driving voltage, a second driving voltage, a first initialization voltage, and a second initialization voltage. According to some embodiments, the bypass voltage line may be electrically connected to a voltage line that delivers one of the second driving voltage, the first initialization voltage, and the second initialization voltage.

According to some embodiments, the display panel may include a center area and an edge area placed sequentially in a first direction. According to some embodiments, the scan driving circuit may be placed adjacent to the edge area. According to some embodiments, the data driving circuit may include a first driving circuit corresponding to the center area and a second driving circuit corresponding to the edge area. According to some embodiments, the first driving circuit may provide the third switching signal to a clock line.

### BRIEF DESCRIPTION OF THE DRAWINGS

The above and other aspects and features of embodiments according to the present disclosure will become more apparent by describing in more detail aspects of some embodiments thereof with reference to the accompanying drawings.

FIG. 1 is a block diagram of an electronic device, according to some embodiments.

FIG. 2 is a schematic diagram of electronic devices, according to some embodiments.

FIG. 3 is a schematic plan view showing a display module.

FIG. 4 is a block diagram of a display module, according to some embodiments of the present disclosure.

FIG. 5 is a circuit diagram of a pixel, according to some embodiments of the present disclosure.

FIG. 6 shows a circuit configuration of a demultiplexer, according to some embodiments of the present disclosure.

FIG. 7A shows a voltage corresponding to a data signal provided to a first data line, scan signals provided to i-th scan lines, and a third switching signal.

FIG. 7B shows a voltage corresponding to a data signal provided to an m/2-th data line, scan signals provided to i-th scan lines, and a third switching signal.

FIG. 8A is a drawing for describing an operation of a pixel placed in an edge area.

FIG. 8B is a drawing for describing an operation of a pixel placed in a center area.

FIGS. 9A and 9B are drawings showing images displayed on a display panel.

FIG. 10 is a schematic plan view showing a display module.

FIG. 11A shows a voltage corresponding to a data signal provided to a first data line, scan signals provided to i-th scan lines, and a third switching signal.

FIG. 11B shows a voltage corresponding to a data signal provided to an m/2-th data line, scan signals provided to i-th scan lines, and a third switching signal.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

The same sign refers to the same element. Also, in drawings, the thickness, ratio, and dimension of components are exaggerated for effectiveness of description of technical contents. The term “and/or” includes one or more combinations of the associated listed items.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The terms of a singular form includes plural forms unless otherwise specified.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, aspects of some embodiments of the present disclosure will be described in more detail with reference to accompanying drawings.

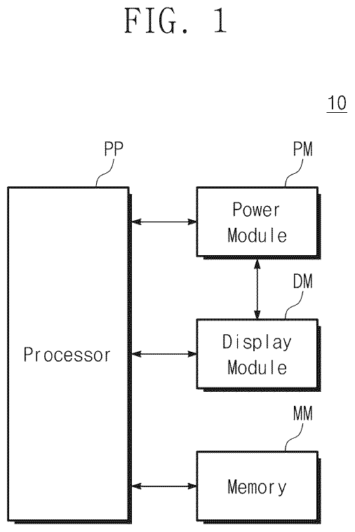

FIG. 1 is a block diagram of an electronic device 10, according to some embodiments.

Referring to FIG. 1, the electronic device 10 according to some embodiments may include a display module DM, a processor PP, a memory MM, and a power module PM, although embodiments according to the present disclosure are not limited thereto.

The processor PP may include at least one of a central processing unit (CPU), an application processor (AP), a graphic processing unit (GPU), a communication processor (CP), an image signal processor (ISP), or a controller.

The memory MM may store data information necessary for the operation of the processor PP or the display module DM. When the processor PP launches an application stored in the memory MM, image data signals and/or input control signals may be delivered to the display module DM, and the display module DM may process the received signals and may output image information through a display screen.

The power module PM may include a power supply module, such as a power adapter or a battery device, and a power conversion module that generates power required for the operation of the electronic device 10 by converting power supplied by the power supply module.

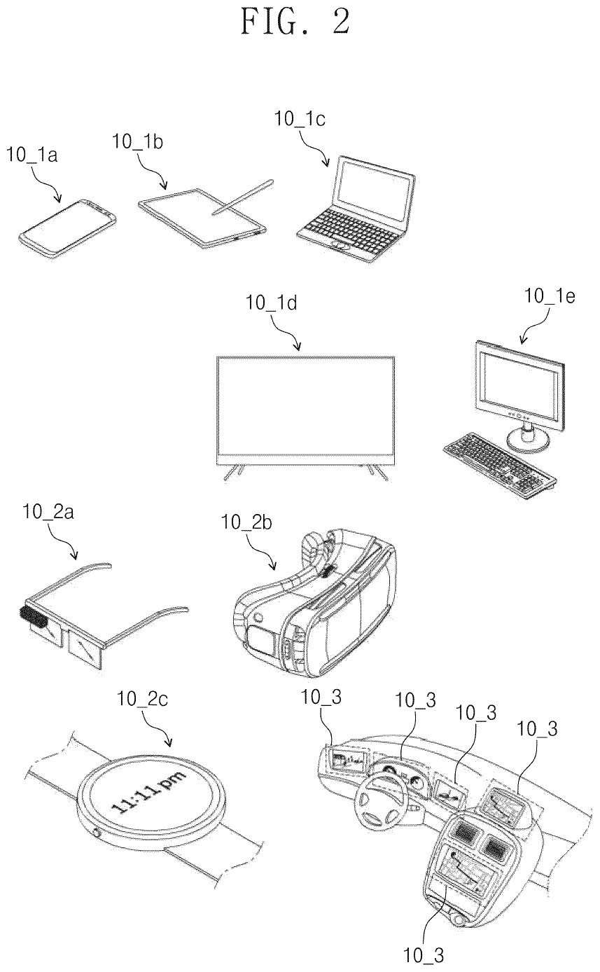

FIG. 2 is a schematic diagram of electronic devices, according to various embodiments.

Referring to FIG. 2, in addition to electronic devices for displaying images, such as a smart phone 10_1a, a tablet PC 10_1b, a laptop 10_1c, a TV 10_1d, a desk monitor 10_1e, various electronic devices according to embodiments may include wearable electronic devices including display modules, such as smart glasses 10_2a, a head-mounted display 10_2b, a smart watch 10_2c, and electronic devices 10_3 for vehicles including display modules, such as a dashboard, a center fascia, a center information display (CID) placed on a dashboard, or a room mirror display of a vehicle.

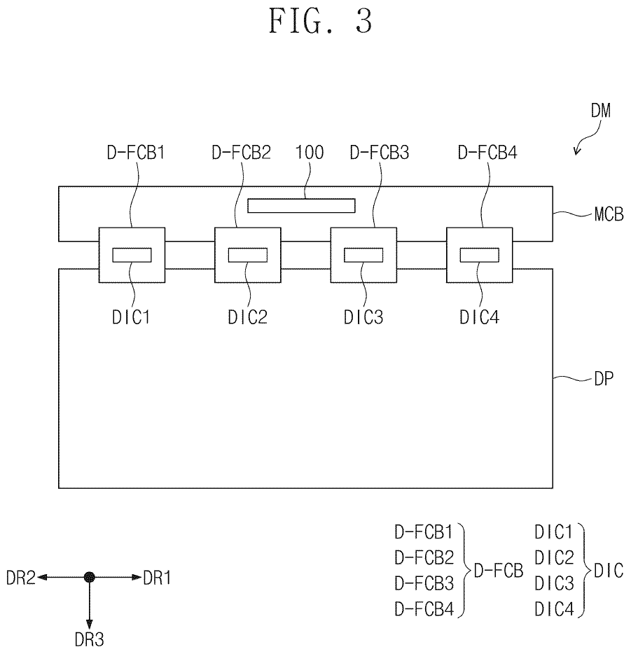

FIG. 3 is a schematic plan view showing further details of the display module DM.

Referring to FIG. 3, the display module DM may include a display panel DP, a main circuit board MCB, flexible circuit films D-FCB, driving circuits DIC, and a driving controller 100. According to some embodiments, the display module DM may be referred to as a “display device”.

The display panel DP according to some embodiments of the present disclosure may be a light-emitting display panel that displays an image.

The main circuit board MCB may be connected to the flexible circuit films D-FCB so as to be electrically connected to the display panel DP. The flexible circuit films D-FCB are connected to the display panel DP so as to electrically connect the display panel DP to the main circuit board MCB. The main circuit board MCB may further include a plurality of elements. Each of the plurality of elements may include a circuit part for driving the display panel DP. The driving circuits DIC may be mounted on the flexible circuit films D-FCB.

As an example of the present disclosure, the flexible circuit films D-FCB may include a first flexible circuit film D-FCB1, a second flexible circuit film D-FCB2, a third flexible circuit film D-FCB3, and a fourth flexible circuit film D-FCB4. The driving circuits DIC may include a first driving circuit DIC1, a second driving circuit DIC2, a third driving circuit DIC3, and a fourth driving circuit DIC4. The first to fourth flexible circuit films D-FCB1, D-FCB2, D-FCB3, and D-FCB4 may be placed spaced from each other in a first direction DR1. The first to fourth flexible circuit films D-FCB1, D-FCB2, D-FCB3, and D-FCB4 may be connected to the display panel DP to electrically connect the display panel DP and the main circuit board MCB. The first to fourth driving circuits DIC1, DIC2, DIC3, and DIC4 may be mounted on the first to fourth flexible circuit films D-FCB1, D-FCB2, D-FCB3, and D-FCB4, respectively. However, embodiments according to the present disclosure are not limited thereto. For example, the display panel DP may be electrically connected to the main circuit board MCB through one flexible circuit film, and only one driving circuit may be mounted on one flexible circuit film. Also, the display panel DP may be electrically connected with the main circuit board MCB through two or more flexible circuit films, and driver circuits may be respectively mounted on the flexible circuit films. Also, the first to fourth driving circuits DIC1, DIC2, DIC3, and DIC4 may be directly mounted on the main circuit board MCB.

According to some embodiments as illustrated in FIG. 3, the display module DM is illustrated as including four driving circuits (i.e., the first to fourth driving circuits DIC1, DIC2, DIC3, and DIC4), but embodiments according to the present disclosure are not limited thereto. The display module DM may include one or more driving circuits.

The driving controller 100 may be mounted on the main circuit board MCB. The driving controller 100 may be electrically connected to the first to fourth driving circuits DIC1, DIC2, DIC3, and DIC4 through the first to fourth flexible circuit films D-FCB1, D-FCB2, D-FCB3, and D-FCB4. Moreover, the driving controller 100 may be electrically connected to the display panel DP through the first to fourth flexible circuit films D-FCB1, D-FCB2, D-FCB3, and D-FCB4.

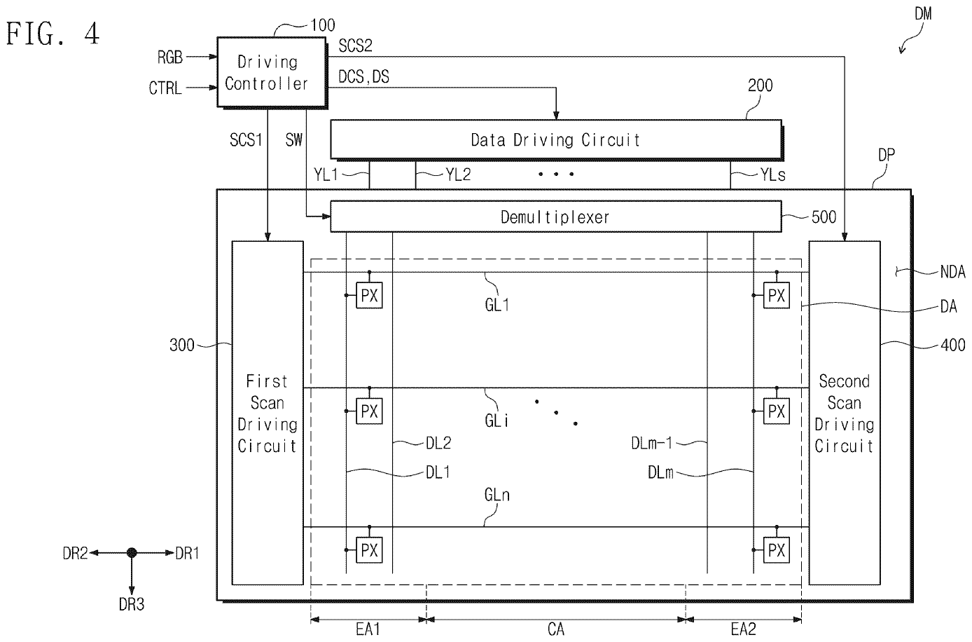

FIG. 4 is a block diagram of the display module DM, according to some embodiments of the present disclosure.

Referring to FIG. 4, the display module DM includes the driving controller 100, a data driving circuit 200, a first scan driving circuit 300, a second scan driving circuit 400, and the display panel DP.

The driving controller 100 receives an input image signal RGB and a control signal CTRL. The input image signal RGB and the control signal CTRL may be provided from the processor PP illustrated in FIG. 1.

The driving controller 100 generates an output image signal DS obtained by converting the input image signal RGB into an image type suitable for the display panel DP. The driving controller 100 may output a switching signal SW, a first scan control signal SCS1, a second scan control signal SCS2, and a data control signal DCS.

According to some embodiments of the present disclosure, the display panel DP may include a light emitting display panel. For example, the display panel DP may be an organic light emitting display panel, an inorganic light emitting display panel, or a quantum dot light emitting display panel. A light emitting layer of the organic light emitting display panel may include an organic luminescent material. A light emitting layer of the inorganic light emitting display panel may include an inorganic luminescent material. A light emitting layer of the quantum dot light emitting display panel may include a quantum dot, a quantum rod, or the like. Hereinafter, according to some embodiments, the description will be given under the condition that the display panel DP is an organic light emitting display panel.

The display panel DP includes scan lines GL1 to GLn, data lines DL1 to DLm, and pixels PX. According to some embodiments, the first scan driving circuit 300 and the second scan driving circuit 400 may be positioned on the display panel DP.

The display panel DP may include a display area DA and a non-display area NDA. The pixels PX may be placed in the display area DA, and the first scan driving circuit 300 and the second scan driving circuit 400 may be placed in the non-display area NDA. According to some embodiments, the display area DA may be an area where images are displayed, and the non-display area NDA may be an area surrounding (e.g., in a periphery, or outside a footprint of) the display area DA.

The display area DA of the display panel DP may be split into a center area CA and edge areas EA1 and EA2. Compared to the edge areas EA1 and EA2, the center area CA may be an area relatively far from the first scan driving circuit 300 or the second scan driving circuit 400.

Each of the pixels PX may be electrically connected to the data driving circuit 200, the first scan driving circuit 300 and the second scan driving circuit 400.

The scan lines GL1 to GLn (‘n’ is a positive integer) extend from the first scan driving circuit 300 in the first direction DR1 and are arranged spaced apart from each other in a third direction DR3. Moreover, the scan lines GL1 to GLn may extend from the second scan driving circuit 400 in the opposite direction (i.e., the second direction DR2) of the first direction DR1. That is, the scan lines GL1 to GLn may be commonly connected to the first scan driving circuit 300 and the second scan driving circuit 400.

The data lines DL1 to DLm (‘m’ is a positive integer) extend from a demultiplexer 500 in the third direction DR3 and are arranged spaced apart from each other in the first direction DR1.

Each of the pixels PX may be connected to a corresponding scan line among the scan lines GL1 to GLn, and may be connected to a corresponding data line among the data lines DL1 to DLm. FIG. 4 illustrates that each of the plurality of pixels PX is connected to one scan line, but embodiments according to the present disclosure are not limited thereto. For example, each of the pixels PX may be electrically connected to two or more scan lines.

The data driving circuit 200 receives the data control signal DCS and the output image signal DS from the driving controller 100. The data driving circuit 200 converts the output image signal DS into data signals and outputs the data signals to output lines YL1 to YLs (‘s’ is a positive integer). Each of the data signals may have a voltage level corresponding to a grayscale level of the output image signal DS thus output. According to some embodiments, the number of output lines YL1 to YLs may be less than the number of data lines DL1 to DLm (i.e., s<m).

The data driving circuit 200 may be implemented as an integrated circuit (IC). The data driving circuit 200 having an IC type may be directly mounted in an area (e.g., a set or predetermined area) of the display panel DP or may be mounted on a separate printed circuit board in a chip on film (COF) scheme, and then may be electrically connected to the display panel DP. According to some embodiments, the data driving circuit 200 may include the first to fourth driving circuits DIC1, DIC2, DIC3, and DIC4 illustrated in FIG. 3.

The first scan driving circuit 300 receives the first scan control signal SCS1 from the driving controller 100. The first scan driving circuit 300 may output scan signals to the scan lines GL1 to GLn in response to the first scan control signal SCS1.

The second scan driving circuit 400 receives the second scan control signal SCS2 from the driving controller 100. The second scan driving circuit 400 may output scan signals to the scan lines GL1 to GLn in response to the second scan control signal SCS2.

According to some embodiments, the first scan driving circuit 300 and the second scan driving circuit 400 may be formed through the same process as the pixels PX.

FIG. 4 illustrates that the first scan driving circuit 300 and the second scan driving circuit 400 are positioned on the display panel DP, but embodiments according to the present disclosure are not limited thereto. According to some embodiments, only one of the first scan driving circuit 300 or the second scan driving circuit 400 may be placed on the display panel DP.

The driving controller 100, the data driving circuit 200, the first scan driving circuit 300, and the second scan driving circuit 400 may be driving circuits for providing data signals corresponding to the input image signal RGB to the pixels PX.

The demultiplexer 500 may electrically connect the plurality of output lines YL1 to YLs to the data lines DL1 to DLm in response to the switching signal SW provided from the driving controller 100. The specific circuit configuration and operation of the demultiplexer 500 will be described in more detail later.

According to some embodiments, the demultiplexer 500 may be placed in the non-display area NDA of the display panel DP.

FIG. 4 illustrates that the demultiplexer 500 is located on the display panel DP, but embodiments according to the present disclosure are not limited thereto. According to some embodiments, the demultiplexer 500 may be included in the data driving circuit 200. According to some embodiments, the demultiplexer 500 may be provided in a separate driving circuit or circuit board independent of each of the display panel DP and the data driving circuit 200.

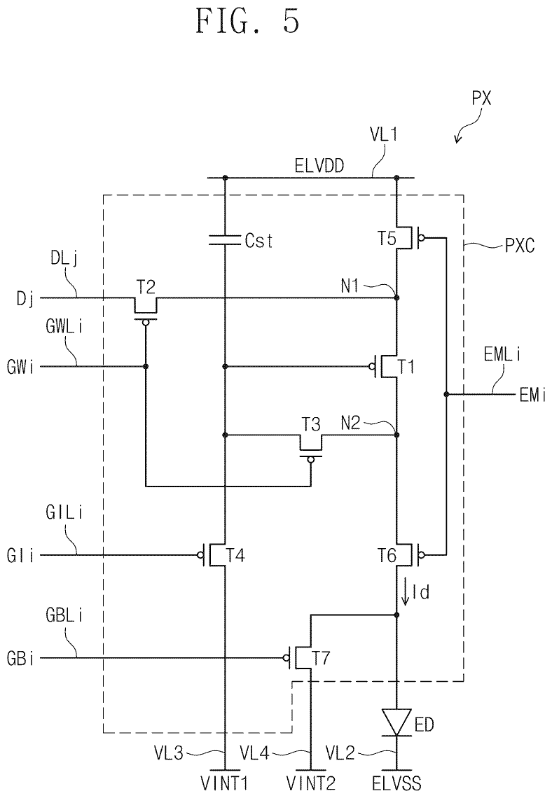

FIG. 5 is a circuit diagram of the pixel PX, according to some embodiments of the present disclosure. Although FIG. 5 illustrates various components in a pixel PX according to some embodiments, embodiments according to the present disclosure are not limited thereto, and according to various embodiments, the pixel PX may include additional components or fewer components without departing from the spirit and scope of embodiments according to the present disclosure.

Referring to FIG. 5, the pixel PX includes a pixel circuit PXC including at least one transistor and at least one capacitor and a light emitting element ED. The pixel PX illustrated in FIG. 5 includes first to seventh transistors T1, T2, T3, T4, T5, T6, and T7 and a capacitor Cst. The pixel PX illustrated in FIG. 5 is only an example, and a circuit configuration of the pixel PX may be modified in various ways.

According to some embodiments, each of the first to seventh transistors T1 to T7 is a P-type transistor having a low-temperature polycrystalline silicon (LTPS) semiconductor layer.

However, embodiments according to the present disclosure are not limited thereto. According to some embodiments, at least one of the first to seventh transistors T1 to T7 may be an N-type transistor using an oxide semiconductor as a semiconductor layer, and the others may be P-type transistors.

According to some embodiments, the pixel PX may be electrically connected to one data line DLj, three scan lines GILi, GWLi, and GBLi, and one emission line EMLi. Each of the scan lines GL1 to GLn illustrated in FIG. 4 may include a plurality of scan lines and at least one emission line. According to some embodiments, the i-th scan line GLi among the scan lines GL1 to GLn illustrated in FIG. 4 may include three of the scan lines GILi, GWLi, and GBLi and one of the emission lines EMLi.

The scan lines GILi, GWLi, and GBLi may respectively deliver scan signals GIi, GWi, and GBi, and the emission line EMLi may transmit an emission control signal EMi. The data line DLj delivers a data signal Dj. The data signal Dj may have a voltage level corresponding to the image signal RGB to be input to the display module DM (see FIG. 4). First to fourth driving voltage lines VL1, VL2, VL3, and VL4 may transfer a first driving voltage ELVDD, a second driving voltage ELVSS, a first initialization voltage VINT1, and a second initialization voltage VINT2, respectively.

The first transistor T1 is connected between a first node N1 and a second node N2, and includes a gate electrode connected to one end of the capacitor Cst.

The second transistor T2 is connected between the data line DLj and the first node N1, and includes a gate electrode connected to the scan line GWLi. The second transistor T2 may be turned on in response to the scan signal GWi received through the scan line GWLi and may deliver the data signal Dj received from the data line DLj to the first node N1 (i.e., the first electrode of the first transistor T1).

The third transistor T3 is connected between the gate electrode of the first transistor T1 and the second node N2, and includes a gate electrode connected to the scan line GWLi. The third transistor T3 may be turned on in response to the scan signal GWi received through the scan line GWLi, and thus the gate electrode of the first transistor T1 and the second node N2 (i.e., the second electrode of the first transistor T1) may be connected, that is, the first transistor T1 may be diode-connected.

The fourth transistor T4 is connected between the gate electrode of the first transistor T1 and the third driving voltage line VL3 to which the first initialization voltage VINT1 is delivered, and includes a gate electrode connected to the scan line GILi. The fourth transistor T4 may be turned on in response to the scan signal GIi transferred through the scan line GILi such that the first initialization voltage VINT1 is transferred to the gate electrode of the first transistor T1. Accordingly, an initialization operation of initializing a voltage of the gate electrode of the first transistor T1 may be performed.

The fifth transistor T5 is connected between the first driving voltage line VL1 and the first node N1, and includes a gate electrode connected to the emission line EMLi. The sixth transistor T6 is connected between the second node N2 and the light emitting element ED, and includes a gate electrode connected to the emission line EMLi. The fifth transistor T5 and the sixth transistor T6 may be turned on simultaneously in response to the emission control signal EMi received through the emission line EMLi. As the fifth transistor T5 and the sixth transistor T6 are turned on, a current path may be formed from the first driving voltage line VL1 to the light emitting element ED through the fifth transistor T5, the first transistor T1, and the sixth transistor T6. In this case, the current flowing through the first transistor T1 may correspond to charges charged in the capacitor Cst. Accordingly, a current Id corresponding to the data signal Dj may be delivered to the light emitting element ED. In other words, the data signal Dj may be converted into the current Id through the pixel PX, and then the current Id may be provided to the light emitting element ED.

The seventh transistor T7 is connected between the light emitting element ED and the fourth driving voltage line VL4, and includes a gate electrode connected to the scan line GBLi. The seventh transistor T7 may be turned on in response to the scan signal GBi received through the scan line GBLi to initialize the anode of the light emitting element ED with the second initialization voltage VINT2 from the fourth driving voltage line VL4.

As described above, one end of the capacitor Cst is connected to the gate electrode of the first transistor T1, and the other end of the capacitor Cst is connected to the first driving voltage line VL1. The cathode of the light emitting element ED may be connected to the second driving voltage line VL2, to which the second driving voltage ELVSS is delivered.

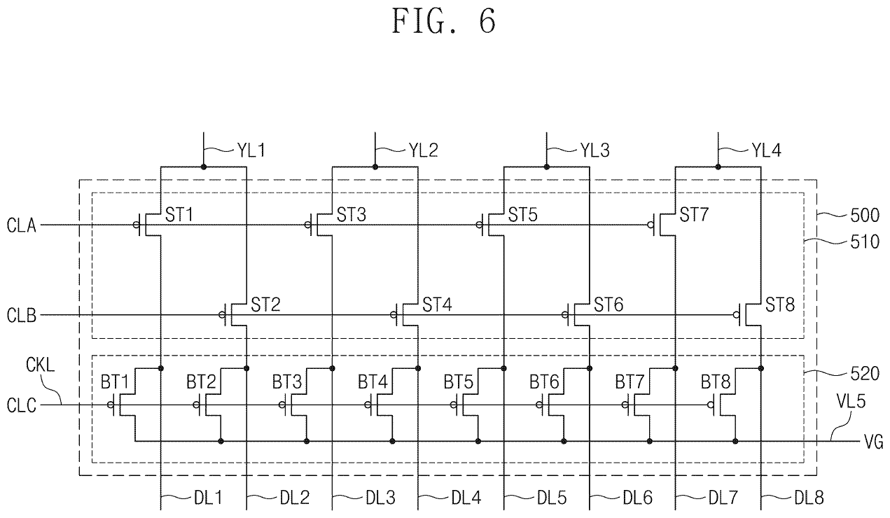

FIG. 6 shows a circuit configuration of the demultiplexer 500, according to some embodiments of the present disclosure.

Referring to FIG. 6, the demultiplexer 500 includes a switching circuit 510 and a bypass circuit 520. The switching circuit 510 includes first switching transistors ST1, ST3, ST5, and ST7 and second switching transistors ST2, ST4, ST6, and ST8.

The first switching transistor ST1 is connected between the output line YL1 and the data line DL1. The first switching transistor ST3 is connected between the output line YL2 and the data line DL3. The first switching transistor ST5 is connected between the output line YL3 and the data line DL5. The first switching transistor ST7 is connected between the output line YL4 and the data line DL7.

The second switching transistor ST2 is connected between the output line YL1 and the data line DL2. The second switching transistor ST4 is connected between the output line YL2 and the data line DL4. The second switching transistor ST6 is connected between the output line YL3 and the data line DL6. The second switching transistor ST8 is connected between the output line YL4 and the data line DL8.

Each of the first switching transistors ST1, ST3, ST5, and ST7 is turned on in response to a first switching signal CLA. When each of the first switching transistors ST1, ST3, ST5, and ST7 is turned on, the output lines YL1, YL2, YL3, and Y4 may be electrically connected to the odd-numbered data lines DL1, DL3, DL5, and DL7.

Each of the second switching transistors ST2, ST4, ST6, and ST8 is turned on in response to a second switching signal CLB. When each of the second switching transistors ST2, ST4, ST6, and ST8 is turned on, the output lines YL1, YL2, YL3, and Y4 may be electrically connected to the even-numbered data lines DL2, DL4, DL6, and DL8.

The bypass circuit 520 includes bypass transistors BT1, BT2, BT3, BT4, BT5, BT6, BT7, and BT8. The bypass transistors BT1, BT2, BT3, BT4, BT5, BT6, BT7, and BT8 are connected between the data lines DL1, DL2, DL3, DL4, DL5, DL6, DL7, and DL8 and a fifth voltage line VL5, respectively. Each of the bypass transistors BT1, BT2, BT3, BT4, BT5, BT6, BT7, and BT8 is turned on in response to a third switching signal CLC. The third switching signal CLC may be delivered to the gate electrode of each of the bypass transistors BT1, BT2, BT3, BT4, BT5, BT6, BT7, and BT8 through a clock line CKL.

When each of the bypass transistors BT1, BT2, BT3, BT4, BT5, BT6, BT7, and BT8 is turned on, a portion of the current flowing through the data lines DL1, DL2, DL3, DL4, DL5, DL6, DL7, and DL8 may be bypassed to the fifth voltage line VL5. According to some embodiments, the fifth voltage line VL5 may provide a ground voltage VG, but embodiments according to the present disclosure are not limited thereto. According to some embodiments, the ground voltage VG may be the same voltage as one of the second driving voltage ELVSS, the first initialization voltage VINT1 or the second initialization voltage VINT2. In this case, the fifth voltage line VL5 may be electrically connected to one of the second driving voltage line VL2, the third driving voltage line VL3, or the fourth driving voltage line VL4.

According to some embodiments, the fifth voltage line VL5 may be electrically connected to one of the voltage lines that deliver voltages required for the operation of the display panel DP as well as voltages required for the operation of the first scan driving circuit 300 or the second scan driving circuit 400.

According to some embodiments, the fifth voltage line VL5 may be referred to as a “bypass voltage line”.

According to some embodiments, the first switching transistors ST1, ST3, ST5, and ST7, the second switching transistors ST2, ST4, ST6, and ST8, and the bypass transistors BT1, BT2, BT3, BT4, BT5, BT6, BT7, and BT8 are P-type transistors. The first switching transistors ST1, ST3, ST5, and ST7, the second switching transistors ST2, ST4, ST6, and ST8, and the bypass transistors BT1, BT2, BT3, BT4, BT5, BT6, BT7, and BT8 may be formed by the same manufacturing process as the first to seventh transistors T1, T2, T3, T4, T5, T6, and T7 of the pixel PX illustrated in FIG. 5.

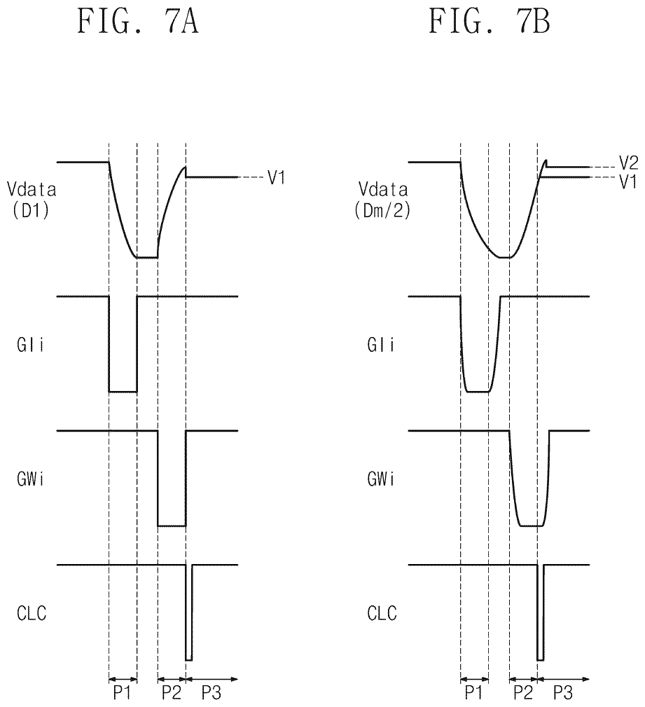

FIG. 7A shows a voltage Vdata corresponding to the data signal D1 provided to the first data line, the scan signals GIi and GWi provided to the i-th scan lines GILi and GWLi, and the third switching signal CLC.

FIG. 7B shows a voltage Vdata corresponding to the data signal Dm/2 provided to the m/2-th data line, scan signals GIi and GWi provided to the i-th scan lines GILi and GWLi, and the third switching signal CLC.

Referring to FIGS. 4, 7A, and 7B, the pixel PX receiving the data signal D1 and the scan signals GIi and GWi is the pixel PX placed in the edge area EA1 of the display panel DP. The pixel PX that receives the data signal Dm/2 and the scan signals GIi and GWi is the pixel PX placed in the center area CA of the display panel DP.

Referring to FIGS. 4 and 7A, when the scan signal GIi transitions to a low level in a first period P1, the fourth transistor T4 is turned on. The first initialization voltage VINT1 is provided to the gate electrode of the first transistor T1 and one end of the capacitor Cst through the fourth transistor T4. The voltage of the gate electrode of the first transistor T1 and the voltage of one end of the capacitor Cst may be initialized to the first initialization voltage VINT1.

When the scan signal GWi transitions to a low level in a second period P2, the second transistor T2 and the third transistor T3 are turned on. The data signal Dj received through the data line DL1 is provided to one end of the capacitor Cst through the second transistor T2, the first transistor T1, and the third transistor T3.

Afterwards, when the emission control signal EMi transitions to a low level, the fifth transistor T5 and the sixth transistor T6 are turned on. As the fifth transistor T5 and the sixth transistor T6 are turned on, the current Id corresponding to the data signal Dj stored in the capacitor Cst is provided to the light emitting element ED, and thus the light emitting element ED emits light.

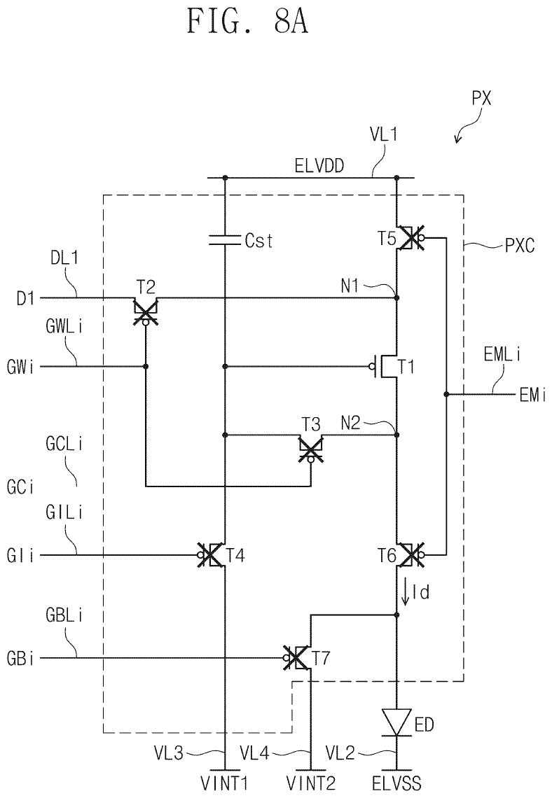

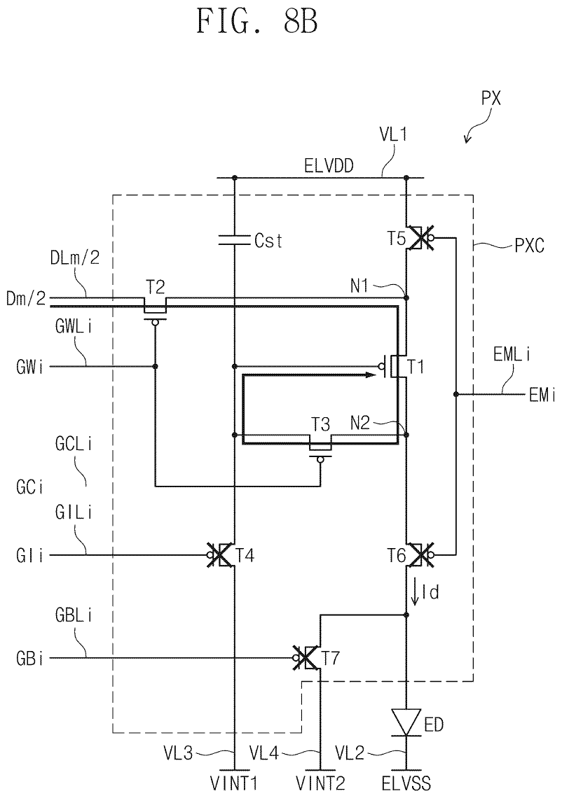

FIG. 8A is a drawing for describing an operation of the pixel PX placed in the edge area EA1.

FIG. 8B is a drawing for describing an operation of the pixel PX placed in the center area CA.

Referring to FIGS. 7A and 8A, the scan signal GWi provided to the pixel PX located in the edge area EA1 adjacent to the first scan driving circuit 300 transitions from a low level to a high level at the start of a third period P3. Accordingly, all of the second to seventh transistors T2, T3, T4, T5, T6, and T7 are turned off.

Referring to FIGS. 7B and 8B, the scan signal GWi provided to the pixel PX located in the center area CA far from the first scan driving circuit 300 and the second scan driving circuit 400 may be maintained at a low level at the start of the third period P3 due to RC delay. In this case, the second transistor T2 and the third transistor T3 may be maintained to be turned on during a part of the third period P3.

Even when the data signals D1 and Dm/2 provided to the data lines DL1 and DLm/2 are the same as each other, the voltage Vdata transmitted to the capacitor Cst in the pixel PX located in the edge area EA1 and the voltage Vdata transmitted to the capacitor Cst in the pixel PX located in the center area CA may be different from each other. The reason is that the time required to provide the data signal Dm/2 to the capacitor Cst in the pixel PX placed in the center area CA is longer than the time required to provide the data signal D1 to the capacitor Cst in the pixel PX placed in the edge area EA1.

According to some embodiments, a voltage level of the voltage Vdata transmitted to the capacitor Cst in the pixel PX placed in the edge area EA1 may be V1, and a voltage level of the voltage Vdata transmitted to the capacitor Cst in the pixel PX placed in the center area CA may be V2. As such, when the voltage Vdata stored in the capacitor Cst of the pixel PX placed in the center area CA and the voltage Vdata stored in the capacitor Cst of the pixel PX placed in the edge area EA1 are different from each other, the luminance of the center area CA and the luminance of the edge area EA1 become different from each other.

Returning to FIGS. 6, 7A and 7B, the third switching signal CLC transitions to a low level at the start of the third period P3. Each of the bypass transistors BT1, BT2, BT3, BT4, BT5, BT6, BT7, and BT8 is turned on in response to the third switching signal CLC of a low level.

As illustrated in FIG. 7A, the scan signal GWi provided to the pixel PX placed in the edge area EA1 transitions from a low level to a high level, and then the third switching signal CLC transitions to a low level. According to some embodiments, the active level period of the scan signal GWi (i.e., the low level period) does not overlap the active level period of the third switching signal CLC (i.e., the low level period). Accordingly, the pixel PX placed in the edge area EA1 is not affected in delivering the data signal D1 to the pixel PX even when the third switching signal CLC transitions to a low level.

As illustrated in FIG. 7B, when the third switching signal CLC transitions to a low level, the bypass transistors BT1, BT2, BT3, BT4, BT5, BT6, BT7, and BT8 are turned on, and thus the data lines DL1, DL2, DL3, DL4, DL5, DL6, DL7, and DL8 are electrically connected to the fifth voltage line VL5 (i.e., the bypass voltage line). Accordingly, a portion of the current flowing through the data lines DL1, DL2, DL3, DL4, DL5, DL6, DL7, and DL8 is bypassed to the fifth voltage line VL5. Even when the scan signal GWi provided to the pixel PX placed in the center area CA is still maintained at a low level at the start of the third period P3, the data signal Dm/2 may be discharged to the ground voltage VG. Accordingly, the voltage level of the voltage Vdata stored in the capacitor Cst of the pixel PX placed in the center area CA may be V1 the same as the voltage Vdata stored in the capacitor Cst of the pixel PX placed in the edge area EA1. According to some embodiments, the time required for the third switching signal CLC to be maintained at a low level may be determined depending on the characteristics of the display panel DP.

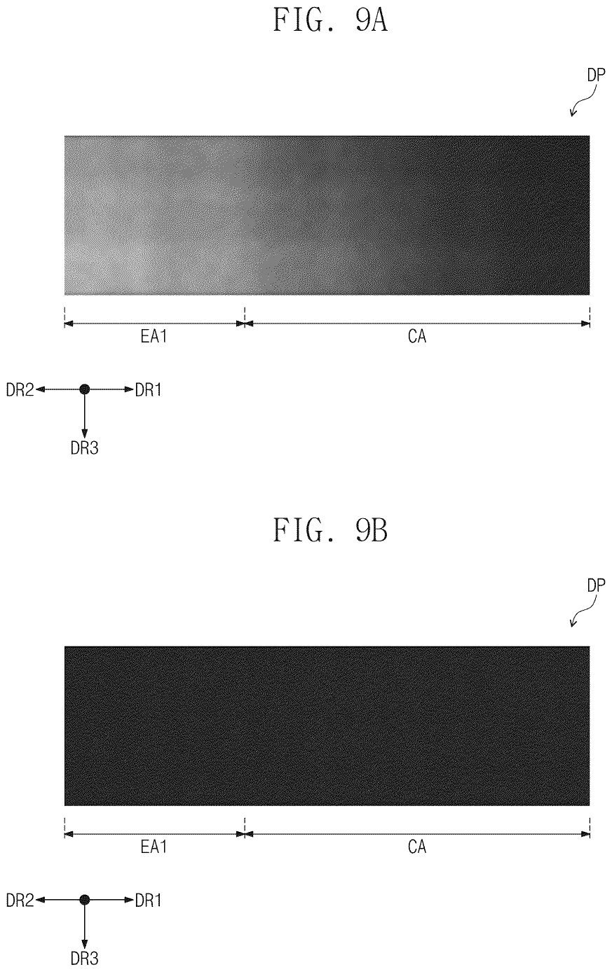

FIGS. 9A and 9B are drawings showing images displayed on the display panel DP.

Referring to FIGS. 4, 6, 7B, and 9A, when the voltage Vdata stored in the capacitor Cst of the pixel PX placed in the center area CA and the voltage Vdata stored in the capacitor Cst of the pixel PX placed in the edge area EA1 are different from each other, the luminance of the center area CA and the luminance of the edge area EA1 may be different from each other.

Referring to FIGS. 4, 6, 7B, and 9B, when the third switching signal CLC transitions to a low level, a portion of the current flowing through the data lines DL1, DL2, DL3, DL4, DL5, DL6, DL7, and DL8 is bypassed to the fifth voltage line VL5. Accordingly, the voltage Vdata stored in the capacitor Cst of the pixel PX placed in the center area CA and the voltage Vdata stored in the capacitor Cst of the pixel PX placed in the edge area EA1 are the same as each other, the luminance of the center area CA and the luminance of the edge area EA1 become the same as each other.

According to some embodiments, sizes of the bypass transistors BT1, BT2, BT3, BT4, BT5, BT6, BT7, and BT8 illustrated in FIG. 6 may be different from each other. As the bypass transistors BT1, BT2, BT3, BT4, BT5, BT6, BT7, and BT8 become larger, the amount of current flowing through the data lines DL1, DL2, DL3, DL4, DL5, DL6, DL7, and DL8 that is bypassed to the fifth voltage line VL5 may increase.

According to some embodiments, the sizes of bypass transistors connected to data lines arranged in the center area CA of the display panel DP may be greater than the sizes of bypass transistors connected to data lines arranged in the edge area EA1. In this case, the amount of current bypassed from data lines placed in the center area CA to the fifth voltage line VL5 may be greater than the amount of current bypassed from data lines placed in the edge area EA1 to the fifth voltage line VL5.

According to some embodiments, the sizes of bypass transistors may be gradually reduced from the center of the display panel DP in the first direction DR1. According to some embodiments, the sizes of bypass transistors may be gradually reduced from the center of the display panel DP in the second direction DR2.

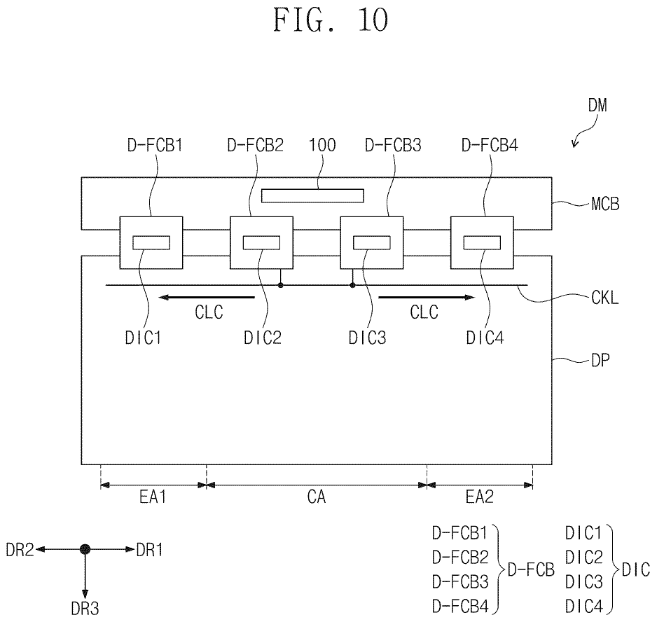

FIG. 10 is a schematic plan view showing the display module DM.

The display module DM illustrated in FIG. 10 includes configurations similar to the display module DM illustrated in FIG. 3. The same reference numerals are used for components, which are the same as components in the display module DM illustrated in FIG. 3, from among the components in the display module DM illustrated in FIG. 10, and some repetitive descriptions may be omitted.

Referring to FIG. 10, the third switching signal CLC may be provided through the clock line CKL in a direction from the center area CA of the display panel DP to the edge area EA1 (i.e., the second direction DR2). Furthermore, the third switching signal CLC may be provided through the clock line CKL in a direction from the center area CA of the display panel DP to the edge area EA2 (i.e., the first direction DR1).

According to some embodiments, the second driving circuit DIC2 and the third driving circuit DIC3 correspond to the center area CA, and the first driving circuit DIC1 and the fourth driving circuit DIC4 correspond to the edge areas EA1 and EA2.

According to some embodiments, the third switching signal CLC is output from the second driving circuit DIC2 and the third driving circuit DIC3 corresponding to the center area CA. However, embodiments according to the present disclosure are not limited thereto. According to some embodiments, the third switching signal CLC may be output from either the second driving circuit DIC2 or the third driving circuit DIC3.

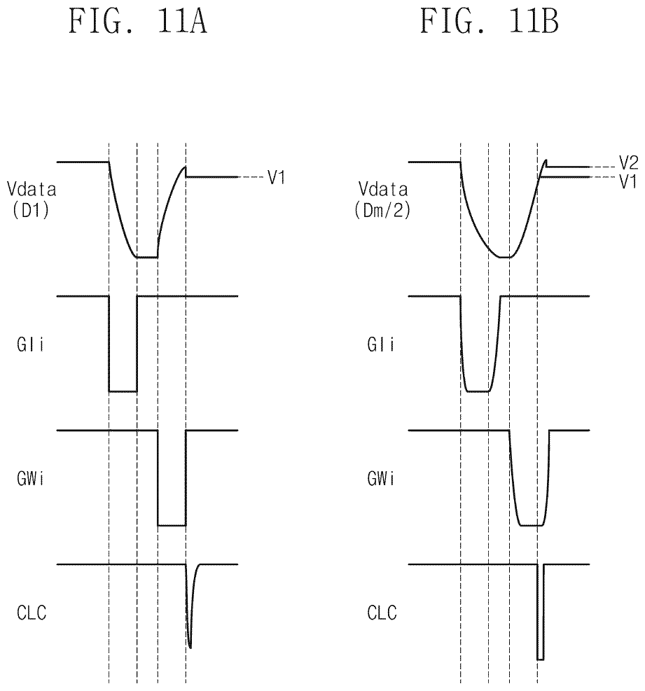

FIG. 11A shows the voltage Vdata corresponding to the data signal D1 provided to the first data line, the scan signals GIi and GWi provided to the i-th scan lines GILi and GWLi, and the third switching signal CLC.

FIG. 11B shows the voltage Vdata corresponding to the data signal Dm/2 provided to the m/2-th data line, the scan signals GIi and GWi provided to the i-th scan lines GILi and GWLi, and the third switching signal CLC.

Referring to FIGS. 4, 10, 11A, and 11B, the pixel PX receiving the data signal D1 and the scan signals GIi and GWi is the pixel PX placed in the edge area EA1 of the display panel DP. The pixel PX that receives the data signal Dm/2 and the scan signals GIi and GWi is the pixel PX placed in the center area CA of the display panel DP.

The scan signal GWi is delivered from the edge area EA1 of the display panel DP to the center area CA, and thus it is maintained at a low level at the start of the third period P3. As the third switching signal CLC is transitions to a low level at the start of the third period P3, a portion of the current flowing through the data lines DL1, DL2, DL3, DL4, DL5, DL6, DL7, and DL8 may be bypassed to the fifth voltage line VL5.

The third switching signal CLC may be delivered in a direction from the center area CA of the display panel DP to the edge area EA1 (i.e., the second direction DR2). Due to RC delay, the waveform of the third switching signal CLC corresponding to the pixel PX placed in the edge area EA1 may be different from the waveform of the third switching signal CLC corresponding to the pixel PX placed in the center area CA.

Because the third switching signal CLC is output from the second driving circuit DIC2 and the third driving circuit DIC3 corresponding to the center area CA, the amount of current bypassed from data lines placed in the center area CA to the fifth voltage line VL5 may be greater than the amount of current bypassed from data lines placed in the edge area EA1 to the fifth voltage line VL5.

As a result, a voltage level of the voltage Vdata transmitted to the capacitor Cst in the pixel PX placed in the edge area EA1, and a voltage level of the voltage Vdata transmitted to the capacitor Cst in the pixel PX placed in the center area CA may be V1.

Although aspects of some embodiments of the present disclosure have been described for illustrative purposes, those skilled in the art will appreciate that various modifications, and substitutions are possible, without departing from the scope and spirit of the present disclosure as disclosed in the accompanying claims. Accordingly, the technical scope of embodiments according to the present disclosure are not limited to the detailed description of this specification, but should be defined by the claims.

An electronic device having such a configuration may include a demultiplexer for connecting output lines of a data driving circuit to data lines, thereby reducing the production cost of a display device. Furthermore, the demultiplexer may include the bypass circuit, and thus may discharge a portion of data signals provided to data lines through the bypass circuit. In particular, the charging current of a data signal provided to pixels positioned in the center area of a display panel is discharged through the bypass circuit, thereby compensating for a luminance difference between the center area and an edge area of the display panel. Accordingly, the display quality of an image displayed on the electronic device may be relatively improved.

While the present disclosure has been described with reference to embodiments thereof, it will be apparent to those of ordinary skill in the art that various changes and modifications may be made thereto without departing from the spirit and scope of the present disclosure as set forth in the following claims, and their equivalents.

What is claimed is:

1. A display device comprising:
a display panel including a first pixel connected to a first data line and a scan line, and a second pixel connected to a second data line and the scan line;
a scan driving circuit configured to output a scan signal to the scan line;
a data driving circuit configured to output a data signal; and
a demultiplexer configured to provide the data signal to the first data line and the second data line,
wherein the demultiplexer includes:
a switching circuit configured to deliver the data signal to the first data line in response to a first switching signal and to deliver the data signal to the second data line in response to a second switching signal; and
a bypass circuit configured to electrically connect the first data line and the second data line to a bypass voltage line in response to a third switching signal.

2. The display device of claim 1, wherein the bypass circuit includes:
a first bypass transistor connected between the first data line and the bypass voltage line and configured to be turned on in response to the third switching signal; and
a second bypass transistor connected between the second data line and the bypass voltage line and configured to be turned on in response to the third switching signal.

3. The display device of claim 1, wherein a ground voltage is provided to the bypass voltage line.

4. The display device of claim 1, wherein an active level period of the scan signal does not overlap an active level period of the third switching signal.

5. The display device of claim 1, wherein the demultiplexer is on the display panel.

6. A display device comprising:
a display panel including a plurality of first pixels connected to a plurality of first data lines and a scan line, and a plurality of second pixels connected to a plurality of second data lines and the scan line;
a scan driving circuit configured to output a scan signal to the scan line;
a data driving circuit configured to output a plurality of data signals; and
a demultiplexer configured to provide the plurality of data signals to the plurality of first data lines and the plurality of second data lines,
wherein the demultiplexer includes:
a switching circuit configured to deliver the plurality of data signals to the plurality of first data lines in response to a first switching signal and to deliver the plurality of data signals to the plurality of second data lines in response to a second switching signal; and
a bypass circuit configured to connect the plurality of first data lines to a bypass voltage line and to connect the plurality of second data lines to the bypass voltage line, in response to a third switching signal.

7. The display device of claim 6, wherein the bypass circuit includes:
a plurality of bypass transistors, each of which is connected between the bypass voltage line and a corresponding data line among the plurality of first data lines and the plurality of second data lines, and which are configured to be turned on in response to the third switching signal.

8. The display device of claim 7, wherein a ground voltage is provided to the bypass voltage line.

9. The display device of claim 7, wherein an active level period of the scan signal does not overlap an active level period of the third switching signal.

10. The display device of claim 7, wherein the display panel includes an edge area and a center area placed sequentially in a first direction,
wherein the scan driving circuit is adjacent to the edge area, and
wherein among a plurality of bypass transistors, a size of a bypass transistor corresponding to the center area is greater than a size of a bypass transistor corresponding to the edge area.

11. The display device of claim 7, wherein the display panel includes a center area and an edge area placed sequentially in a first direction,
wherein the scan driving circuit is adjacent to the edge area,
wherein each of a plurality of bypass transistors is placed sequentially in the first direction, and
wherein a size of each of the plurality of bypass transistors gradually decreases in the first direction.

12. The display device of claim 7, wherein the display panel includes a center area and an edge area placed sequentially in a first direction,
wherein the scan driving circuit is adjacent to the edge area,
wherein each of a plurality of bypass transistors is placed sequentially in the first direction, and
wherein among the plurality of bypass transistors, the third switching signal is provided sequentially from a bypass transistor corresponding to the center area to a bypass transistor corresponding to the edge area.

13. The display device of claim 6, wherein the display panel includes a center area and an edge area placed sequentially in a first direction,
wherein the data driving circuit includes a first driving circuit corresponding to the center area and a second driving circuit corresponding to the edge area, and
wherein the first driving circuit is configured to provide the third switching signal to a clock line.

14. The display device of claim 6, wherein each of the plurality of first pixels includes:
a first transistor connected between a first node and a second node and including a gate electrode;
a second transistor connected between one of the plurality of first data lines and the first node and including a gate electrode configured to receive the scan signal; and
a third transistor connected between the second node and the gate electrode of the first transistor and including a gate electrode configured to receive the scan signal.

15. An electronic device comprising:
a processor configured to output an image signal and a control signal; and
a display module configured to display an image in response to the image signal and the control signal,
wherein the display module includes:
a display panel including a first pixel connected to a first data line and a scan line, and a second pixel connected to a second data line and the scan line;
a scan driving circuit configured to output a scan signal to the scan line;
a data driving circuit configured to output a data signal; and
a demultiplexer configured to provide the data signal to the first data line and the second data line,
wherein the demultiplexer includes:
a switching circuit configured to deliver the data signal to the first data line in response to a first switching signal and to deliver the data signal to the second data line in response to a second switching signal; and
a bypass circuit configured to electrically connect the first data line and the second data line to a bypass voltage line in response to a third switching signal.

16. The electronic device of claim 15, wherein the bypass circuit includes:
a first bypass transistor connected between the first data line and the bypass voltage line and configured to be turned on in response to the third switching signal;
and a second bypass transistor connected between the second data line and the bypass voltage line and configured to be turned on in response to the third switching signal,
wherein a ground voltage is provided to the bypass voltage line.

17. The electronic device of claim 15, wherein the display panel includes a display area and a non-display area adjacent to the display area,
wherein the first pixel and the second pixel are in the display area,
wherein the demultiplexer is in the non-display area, and
wherein the demultiplexer includes at least one bypass transistor.

18. The electronic device of claim 15, wherein an active level period of the scan signal does not overlap an active level period of the third switching signal.

19. The electronic device of claim 15, wherein the display panel is configured to receive a first driving voltage, a second driving voltage, a first initialization voltage, and a second initialization voltage, and
wherein the bypass voltage line is electrically connected to a voltage line configured to provide one of the second driving voltage, the first initialization voltage, or the second initialization voltage.

20. The electronic device of claim 15, wherein the display panel includes a center area and an edge area placed sequentially in a first direction,
wherein the scan driving circuit is adjacent to the edge area,
wherein the data driving circuit includes a first driving circuit corresponding to the center area and a second driving circuit corresponding to the edge area, and
wherein the first driving circuit is configured to provide the third switching signal to a clock line.
